(19) United States
(12) Patent Application Publication
(10) Pub. No.: US 2008/0204552 A1
(43) Pub. Date: Aug. 28, 2008

(54) DEVICE FOR MONITORING WITH AT LEAST ONE VIDEO CAMERA

(76) Inventors: Wolfgang Niem, Hildesheim (DE); Andre Gerlach, Gerlingen (DE); Stefan Mueller-Schneiders, Hildesheim (DE); Jan Klijn, Breda (NL); Rene Van Gils, Berkel-Enschot (NL); Peter Wouters, Al Best (NL); Frank Verschuren, Er Lage Mierde (NL)

Correspondence Address: STRIKER, STRIKER & STENBY, 103 EAST NECK ROAD, HUNTINGTON, NY, 11743, US

(21) Appl. No.: 11/565,312

(22) Filed: Nov. 30, 2006

(30) Foreign Application Priority Data
Dec. 2, 2005 (DE) 10 2005 057 569.2

(51) Int. Cl. H04N 7/18

(52) U.S. Cl. 348/143; 348/E07.085

(57) ABSTRACT

A device for monitoring, comprising at least one video camera, a unit for moving the at least one video camera by swivelling, tilting, and swivelling and tilting, an acoustic locating unit configured for determining a direction from which a noise of a specified type arrives, and a control unit for receiving signals from the locating unit and controlling the moving unit such that the at least one video camera is pointed in the direction of the noise.

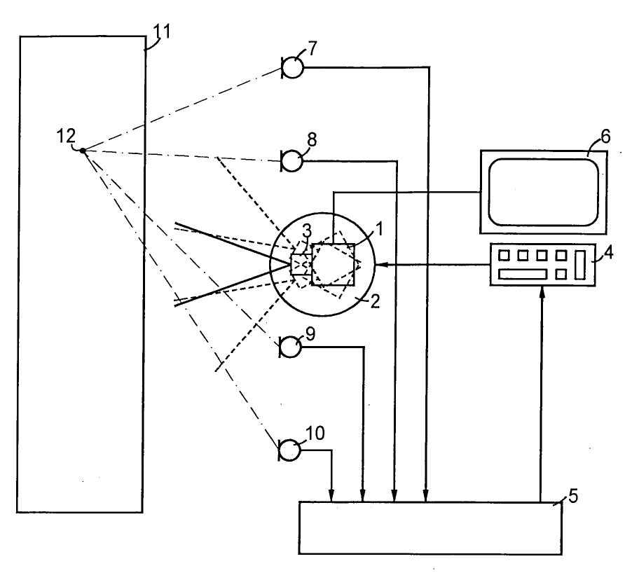

### CROSS-REFERENCE TO A RELATED APPLICATION

The invention described and claimed hereinbelow is also described in German Patent Application DE 102005057569.2 filed on Dec. 2, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a device for monitoring with at least one video camera which is provided with a swivel and/or tilt device.

Diverse types of monitoring devices with video cameras have been made known. It is known, for example, to mount video cameras on a swivel and tilt device, so they can be pointed in various directions via remote control. Often, a remote-controllable zoom lens is also provided. Performing monitoring using a camera of this type requires the constant attention of an operator, however.

In a typical application of monitoring systems of this type, in which the operator watches one or more screens at a location away from the camera or several cameras, there is another disadvantage, namely that the operator does not have any information about what is happening outside of the particular recording area, that is, he is unable to swivel or tilt the camera as necessary. A similar disadvantage exists with cameras which can be swiveled and/or tilted automatically using a specified program. In this case, whether or not the camera is pointed in the correct direction at the correct point in time depends on luck.

These disadvantages are not eliminated by an “AutoDome” camera, which is described in the publication “BOSCH ST AutoDome camera”, with which a camera with a swivel, tilt and zoom device follows the strongest motion in the scene which is recorded. A monitoring device made known in DE 201 04 329 U1 includes sensors, with the aid of which a monitoring camera and infrared illumination are activated automatically. With this known monitoring device, the problem of automatically pointing a swivelable and tiltable camera toward an observed event is not solved, however.

### SUMMARY OF THE INVENTION

Accordingly, it is an object of the present invention to provide a device for monitoring at least one video camera, which avoids the disadvantages of the prior art.

In keeping with these objects, one feature of the present invention resides, briefly stated, in a device for monitoring, comprising at least one video camera; means for moving said at least one video camera and selected from the group consisting of swivel means, tilting means, and swivel and tilting means; acoustic locating means configured for determining a direction from which a noise of a specified type arrives; and control means for receiving signals from said locating means and controlling said moving means such that said at least one video camera is pointed in the direction of the noise.

The inventive device makes it possible to point the video camera without intervention by an operator by the fact that an acoustic locating device is provided which determines the direction from which a noise of a specified type arrives, and that a control device receives signals from the locating device and controls the swivel and/or tilt device such that the at least one video camera is pointed in the direction of the noise.

The inventive device can be used, e.g., at a large site monitored by video cameras, to point the monitoring cameras toward the site of the event if an accident or dispute arises, e.g., in response to a policeman blowing on a police whistle.

According to a refinement of the present invention, the at least one video camera includes a zoom lens which is adjusted with a large focal distance when the noise is detected. This refinement can be used, e.g., when a whistle is blown, to first point the video camera which records the entire scene in the direction of the whistle-blowing, and to simultaneously display the site of the event in an enlarged view by actuating the zoom.

According to an advantageous embodiment of the inventive device, the locating device is composed of several microphones and an audio analyzer. It is preferably provided that the audio analyzer is designed to filter the signals generated by the microphones and measure the phase differences between the signals. Methods which are suited as software implementation and which are used to locate noises (directional determination) are known.

A method of this type is described, e.g., in:

R. Aichner, H. Buchner, F. Yan, and W. Kellermann, “Real-Time Convolutive Blind Source Separation based on a Broadband Approach,” Proc. Int. Symposium on Independent Component Analysis and Blind Source Separation (ICA), Granada, Spain, September 2004.

Standard speech-recognition technology can be used to detect certain signals (police whistles, screams, . . . ) The basic principles of this technology are described in L. R. Rabiner, “A Tutorial on Hidden Markov Models and Selected Applications in Speech Recognition”, Proc. IEEE, Vol. 77, No. 2, February 1989, pp. 257-286.

The novel features of the which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view showing a device for monitoring with at least one video in accordance with the present invention.

### DESCRIPTION OF THE PREFERRED EMBODIMENTS

The drawing shows a block diagram of an inventive device with a video camera 1 which is mounted on a swivel and tilt device 2, and which includes a zoom lens 3. The focal distance and the swiveling and tilting can be controlled by a control device 4. Control device 4 is equipped with various operating and display elements which allow it to controlled manually.

Control device 4 can also receive signals from a processor 5, however, which serves to point the camera in a certain direction and adjust the focal distance. The images which are recorded can be depicted and observed on a screen 6. To illustrate the swivel motion of video camera 1, three different positions are shown in the drawing with their angle of view. The scene 11 to be monitored is depicted schematically as a rectangle.

Four microphones 7, 8, 9, 10 record the noise stemming from scene 11 to be monitored. A noise stemming from a point 12 in scene 11 takes different lengths of time to reach microphones 7 through 10. The travel-time differences are evaluated in a processor 5 with the aid of suitable programs, thereby determining the direction of point 12 from which camera 1 sees point 12. To this end, microphones 7 through 10 are connected with processor 5 via analog/digital converters, which are not shown individually.

Processor 5 then forwards the control information to a control device 4 which converts it into corresponding position data for swivel and tilt device 2 and zoom lens 3. Control device 4 is preferably designed such that control via processor 5 can be overridden by manual input, thereby enabling an operator to select another direction or zoom setting if necessary.

It will be understood that each of the elements described above, or two or more together, may also find a useful application in other types of constructions differing from the type described above.

While the invention has been illustrated and described as embodied in a device for monitoring with at least one video camera, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for monitoring, comprising at least one video camera; means for moving said at least one video camera and selected from the group consisting of swivel means, tilting means, and swivel and tilting means; acoustic locating means configured for determining a direction from which a noise of a specified type arrives; and control means for receiving signals from said locating means and controlling said moving means such that said at least one video camera is pointed in the direction of the noise.

2. A device as defined in claim 1, wherein said at least one video camera includes a zoom lens which is adjusted with a large focal distance when the noise is detected.

3. A device as defined in claim 1, wherein said locating means includes several microphones and an audio analyzer.

4. A device as defined in claim 3, wherein said audio analyzer is configured so as to filter signals generated by said microphones and measure phase differences between the signals.
